(19) United States
(12) Patent Application Publication
(10) Pub. No.: US 2004/0187813 A1
(43) Pub. Date: Sep. 30, 2004

(54) Two-stroke engine

(76) Inventor: Neal W. Meyer, Corvallis, OR (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/402,051

(22) Filed: Mar. 27, 2003

(51) Int. Cl. F02B 33/04

(52) U.S. Cl. 123/73 AD

(57) ABSTRACT

A stroke internal combustion engine includes a piston slideably disposed within a cylinder. The cylinder and said piston together define a combustion chamber. The piston is configured to have a two-stroke cycle comprising a downstroke when said piston slides from an upper position to a lower position within said cylinder and an upstroke when said piston slides from said lower position to said upper position within said cylinder. Further, the engine includes a supply of lubricating fluid that is isolated from any fuel.

### BACKGROUND

The present invention relates to an improved two-stroke internal combustion engine.

Two-stroke engines are commonly-used in a variety of devices, such as powered lawn and garden equipment, chain saws, personal watercraft, small outboard motors, etc. Two-stroke engines are more desirable in some applications relative to conventional four-stroke engines (commonly-used in automobiles) because two-stroke engines are usually less complex (fewer parts), lighter, and less expensive to manufacture. Nonetheless, two-stroke engines have several disadvantages relative to four-stroke engines. For example, two-stroke engines typically have a significantly shorter useful life than a four-stroke engine. The shorter life is at least partially attributable to the fact that known configurations of two-stroke engines tend to cause the fuel to contaminate the lubricating oil in the engine's crankcase, thereby reducing the lubrication effectiveness of the oil. Thus, moving parts in a two-stroke engine tend to wear out faster than in a four-stroke engine. Further, known configurations of two-stroke engines tend to cause oil from the engine's crankcase to contaminate the air/fuel mixture in the combustion chamber of the. engine's cylinder(s), thereby resulting in higher emissions of undesirable pollutants from the combustion process. This cross-mixing of fuel and oil in a two-stroke engine results in high oil consumption and thereby requires the fuel to be mixed with relatively expensive two-stroke oil, which increases the cost to operate a two-stroke engine. Additionally, the conventional configuration of a two-stroke engine results in a certain amount of unburned fuel to be exhausted through the exhaust port. Not only does this significantly reduce the fuel efficiency of a two-stroke engine, but, because the exhaust of unburned fuel would quickly render known catalytic converters inoperative, known two-stroke engines cannot generally be used in concert with a pollution-reducing catalytic converter. The inability to combine a two-stroke engine with a catalytic converter is one reason why two-stroke engines have not heretofore be used in automobiles.

### BRIEF DESCRIPTION OF THE DRAWINGS

FIG. 1A is a cross-sectional view of an exemplary improved two-stroke engine.

FIG. 1B is a cross-sectional view of the exemplary two-stroke engine in FIG. 1A, shown here at the end of the combustion/exhaust cycle.

FIG. 1C is a cross-sectional view of the exemplary two-stroke engine in FIG. 1A, shown here at the beginning of the induction/compression cycle.

FIG. 1D is a cross-sectional view of the exemplary two-stroke engine in FIG. 1A, shown here as the compression portion of the induction/compression cycle begins.

FIG. 1E is a cross-sectional view of the exemplary two-stroke engine in FIG. 1A, shown here at the beginning of the combustion/exhaust cycle.

FIG. 1F is a cross-sectional view of the exemplary two-stroke engine in FIG. 1A, shown here at the end of the power portion of the combustion/exhaust cycle.

### DETAILED DESCRIPTION

The present invention is hereinafter described in the context of one particular embodiment. It should be noted that one of skill in the art will recognize that modifications to the disclosed embodiment could be made and still remain within the scope and spirit of the invention.

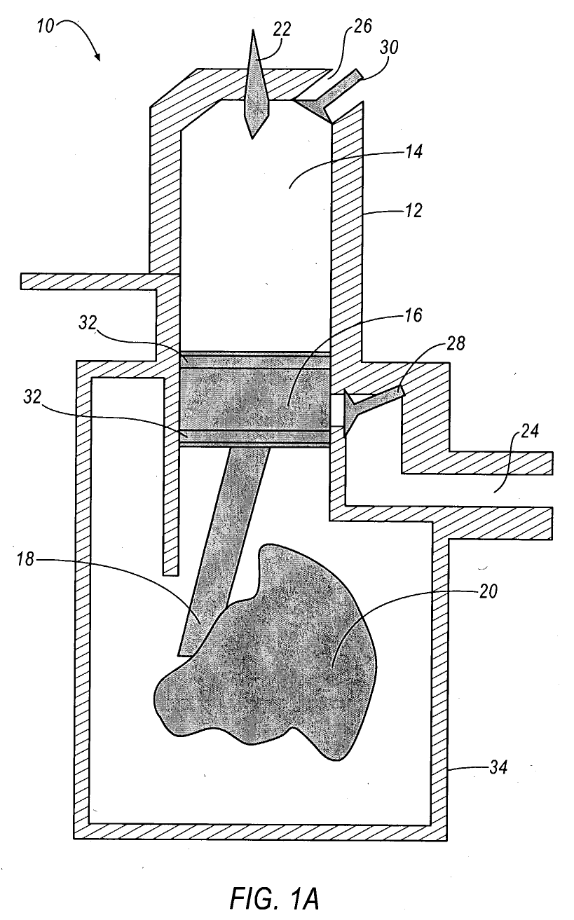

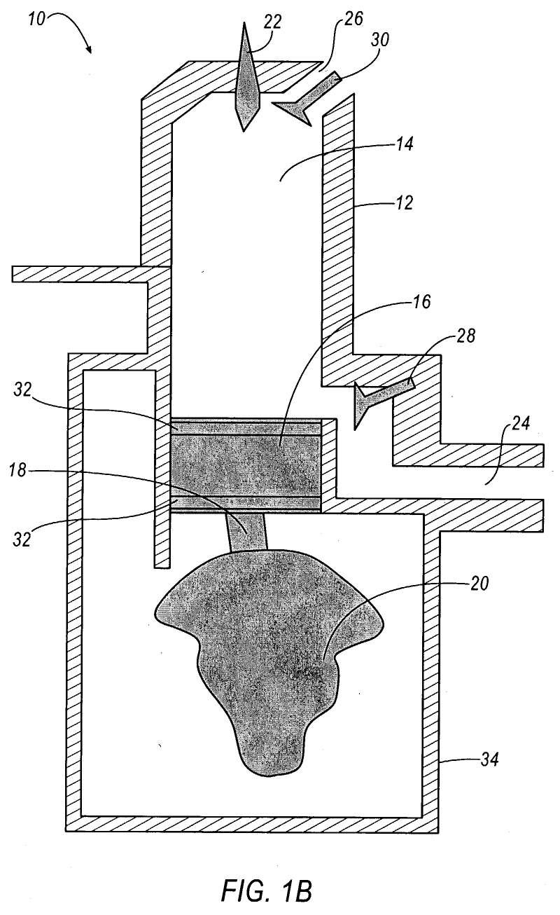

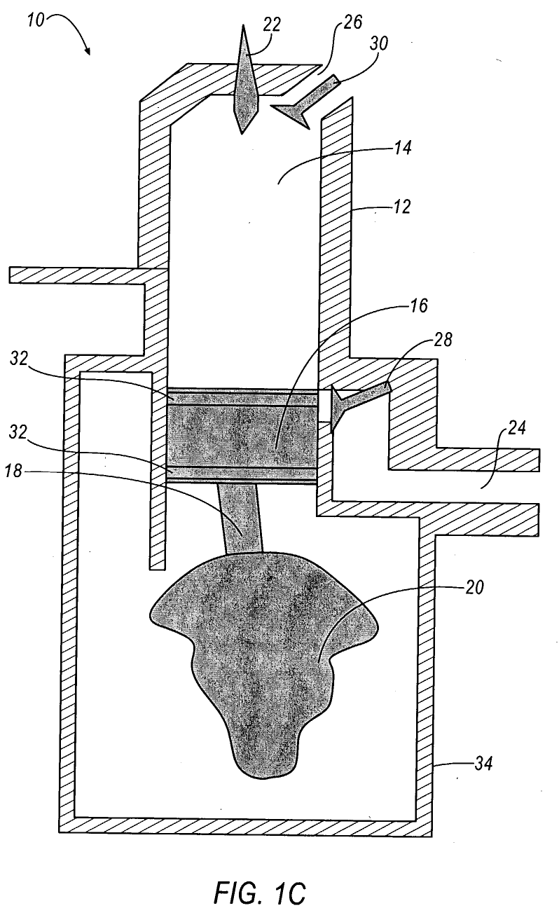

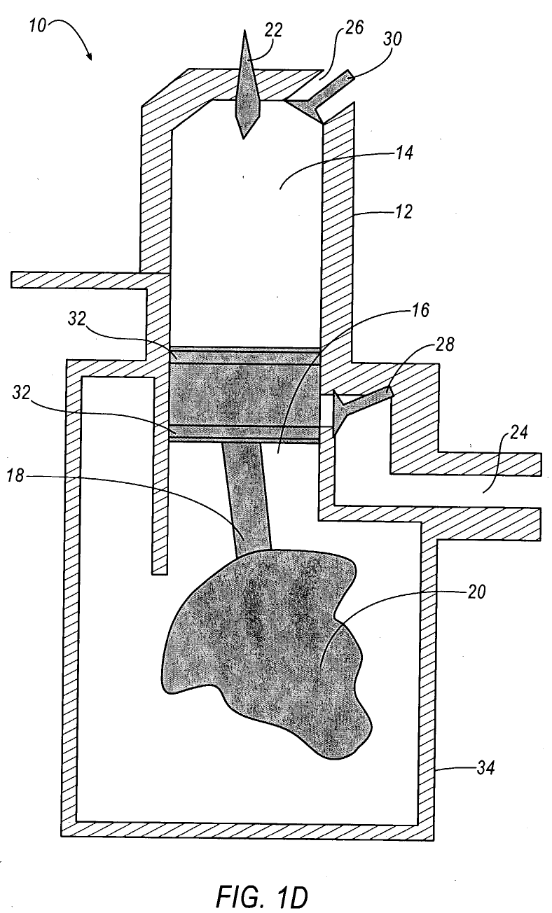

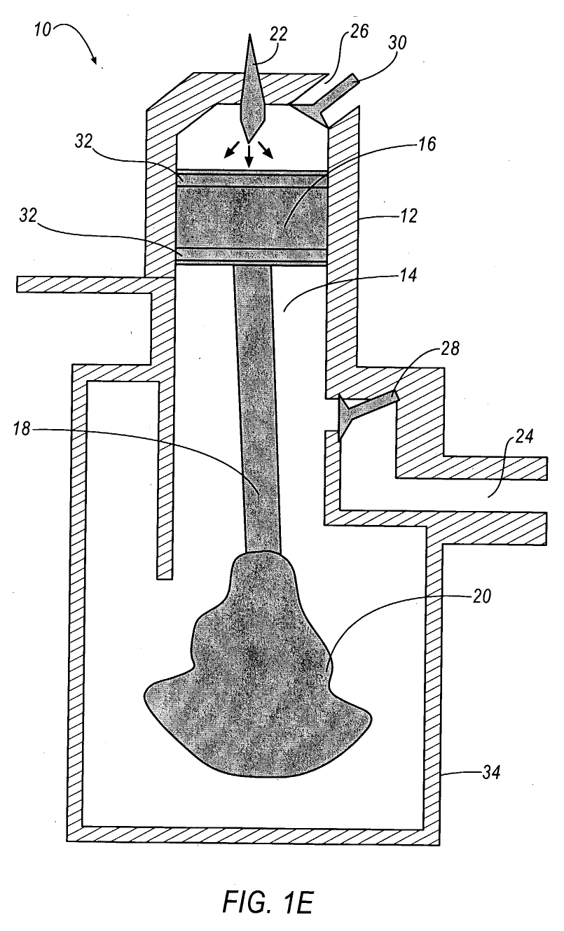

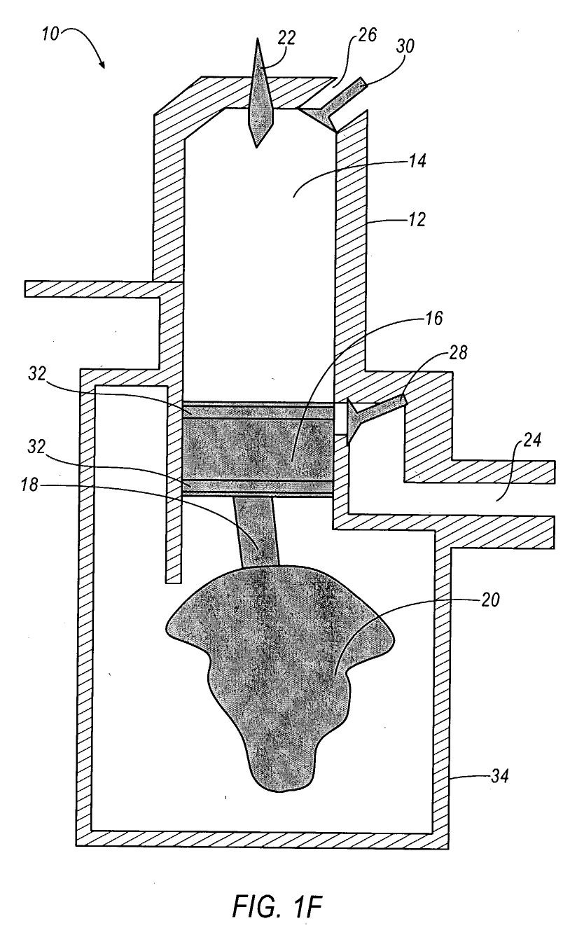

FIGS. 1A-1F illustrate an exemplary embodiment of a single cylinder (at different stages of its cycle) of an improved two-stroke engine. One skilled in the art will recognize that a two-stroke engine may include one or more such cylinder(s). When a two-stroke engine contains more than one cylinder, all of the cylinders could be operated in the same manner as described herein with respect to the single cylinder illustrated in FIGS. 1A-1F.

With reference to FIG. 1A, relevant components of the improved two-stroke engine 10 will now be described. The engine 10 includes a cylinder 12 and a piston 16 slidably disposed in the interior of cylinder 12. While it is common that cylinder 12 actually has a cylindrical shape, it is not necessary to be so. Piston 16 is connected to crank shaft 20 through connecting rod 18. Piston 16 is configured to slide within cylinder 12, thereby causing connecting rod 18 to turn crank shaft 20 to generate rotational movement, which can be used by the device powered by the two-stroke engine. The piston 16 may include sealing gaskets 32.

A combustion chamber 14 is defined by the walls and head of the cylinder 12 and the head of the piston 16. The combustion chamber 14 is configured to receive a mixture of air and fuel, which is compressed by the upward movement of piston 16. The compressed air/fuel mixture is ignited by a spark generated by spark plug 22. Though a gasoline engine is illustrated in the exemplary embodiment, the invention could be implemented in a diesel engine, wherein the air/fuel mixture is ignited by compression. The energy created by the expanding gases from the ignition of the air/fuel mixture in the combustion chamber 14 causes the piston 16 to slide within the cylinder 12. Air is forced into the combustion chamber 14 under pressure through intake port 26. Air can be forced into the combustion chamber 14 in a variety of ways. For instance, an air pump, turbo charger or super charger (none shown in the Figures) could be used to force air into the combustion chamber 14. Fuel can be delivered to the combustion chamber in a variety of ways as well. For instance, fuel can be directly injected into the combustion chamber through a direct fuel injector (not shown) or it could be atomized into the air stream in the intake port 26. Other known methods for causing fuel to be received in the combustion chamber 14 could be used as well. Exhaust gases produced from the combustion of the air/fuel mixture are expelled through exhaust port 24.

In contrast to known configurations of two-stroke engines, intake port 26 is positioned at a higher position within cylinder 12 relative to exhaust port 24. Further, an intake valve 30 is disposed in intake port 26. Intake valve 30 is controlled to selectively open and close the flow path between the intake port 26 and the combustion chamber 14. The intake port 26 is positioned near the upper portion of the cylinder 12 such that air (or an air/fuel mixture, depending on the method of fuel delivery) is delivered to the combustion chamber at the upper portion of the cylinder. Further, exhaust valve 28 is disposed in exhaust port 24. Exhaust valve 28 is controlled to selectively open and close the flow path between the exhaust port 24 and the combustion chamber 14 (which exists when the piston 16 is sufficiently low in the cylinder such that the walls of the piston do not cover the exhaust port 24). Exhaust port 24 is positioned in a lower portion of a sidewall of cylinder 12 such that a flow path between the exhaust port 24 and the combustion chamber 14 can be established only when the piston 14 approaches approximately the lowest part of its oscillation within cylinder 12. The intake valve 30 and the exhaust valve 28 can be controlled (electronically, pneumatically, mechanically or otherwise) by a controller (not shown in the Figures).

A crankcase 34 surrounds crank shaft 20. The crankcase 34 houses a lubricating fluid, such as oil, which maintains adequate lubrication of the various moving components in the system. In contrast to known two-stroke engines, the crankcase 34 is fluidly-isolated from the intake port 26, the exhaust port 24, and the combustion chamber 14. That is, oil from the crankcase 34 cannot pass into the intake port 26, the exhaust port 24, or the combustion chamber 14.

Now, operation of the exemplary configuration of the improved two-stroke engine will be described with reference to FIGS. 1B-1F. A two-stroke engine has two strokes of the piston 16 for each cycle: (i) an induction/compression stroke when the piston 16 is moving upward in the cylinder 12 (also referred to as an “upstroke”); and (ii) a combustion/exhaust stroke when the piston 14 is moving downward in the cylinder 12 (also referred to as a “downstroke”). During the induction/compression stroke, air and fuel are delivered to the combustion chamber 14 and then the air/fuel mixture is compressed as the piston 16 continues to move upward in the cylinder 12 (away from the crank case 34), thereby decreasing the size of the combustion chamber 14. During the combustion/exhaust stroke, the air/fuel mixture is combusted, thereby causing the piston 16 to be forced downward in the cylinder 12 (toward the crank case 34), and the exhaust gases are expelled from the combustion chamber 14. FIG. 1B illustrates the exemplary embodiment when the piston 16 is at the end of its combustion stroke, at which time the piston 16 is near the bottom of the cylinder 12. At this point in the cycle, the air/fuel mixture in the combustion chamber 14 has been combusted and the expanding gas from the combustion has forced the piston 16 downward in the cylinder 12, thereby enlarging the combustion chamber 14 such that it extends at least down to the exhaust port 24. Because the piston 16 is below the exhaust port 24, a flow path can exist between the combustion chamber 14 and the exhaust port 24. The exhaust valve 28 is open to allow exhaust gas from the combustion of the air/fuel mixture to be expelled from the combustion chamber 14. Further, the intake valve 30 is open to allow pressurized air to be injected into the combustion chamber 14 through intake port 26. The pressurized air actually forces the exhaust gases from the combustion of the air/fuel mixture out of the combustion chamber 14 through exhaust port 24 to ready the combustion chamber for the induction/compression stroke of the cycle. The exhaust valve 28 can be maintained in its open position for a determined amount of time to allow all (or substantially all) of the exhaust gases to be expelled from the combustion chamber 14. The exhaust valve 28 may be controlled such that it is moved to its “closed” position at or before the time when the head of the piston 16 begins to pass by the exhaust port 24. In this way, lubricating oil from the crank case 34 and the exterior walls of the piston 16 are prevented from being expelled into the exhaust through the exhaust port 24. As a result, undesirable emissions are reduced relative to known two-stroke engines.

FIG. 1C illustrates the exemplary embodiment as the piston 16 begins the induction/compression stroke of the cycle. The momentum of the crank shaft 20 causes the piston 16 to start to slide upward in the cylinder 12. The exhaust valve 28 is closed before the lower edge of the piston 16 begins to pass the exhaust port 24. Once the exhaust port 24 is closed, fuel may be dispensed into the incoming charge or directly into the combustion chamber 34. The intake valve 30 remains open to allow pressurized air to be forced into combustion chamber 14. Because there is no longer any flow path from the combustion chamber 14 through the exhaust port 24, the incoming air is trapped in the combustion chamber 14.

FIG. 1D illustrates the exemplary embodiment as the piston 16 slides further up into the cylinder during the induction/compression stroke of the cycle. As illustrated, after a given period of time, the intake valve 30 has been closed to close off the flow path between the intake port 26 and the combustion chamber 14, thereby fully enclosing the combustion chamber 14. Once the exhaust port 24 is closed, fuel can be delivered to the combustion chamber 14 according to various methods at different times during the induction/compression stroke of the cycle. For instance, fuel could be mixed with the pressurized air forced into the combustion chamber in the intake port 26, or fuel can be directly injected into the combustion chamber 14 by a direct fuel injector (not shown). In any event, the piston 16 continues to slide upward in the cylinder 12, thereby compressing the trapped air/fuel mixture.

FIG. 1E illustrates the exemplary embodiment 10 as the piston 16 reaches the end of the induction/compression stroke at the top of the cylinder 12. At this point in the cycle, there is maximum compression of the air/fuel mixture in the combustion chamber 14. The spark plug 22 is caused to emit a spark to ignite the compressed air/fuel mixture. In the case where the engine is a diesel engine (not shown), the air/fuel mixture is ignited by the compression alone. The ignition of the air/fuel mixture generates expanding gases, which force the piston 16 downward in the cylinder, which begins the combustion/exhaust stroke of the cycle. As the piston 16 is driven downward in the cylinder 12, the connecting rod 18 turns the crank shaft 20, which generates rotational movement.

FIG. 1F illustrates the exemplary embodiment 10 as the piston 16 continues to slide downward in the cylinder 12, just as the head of the piston 16 starts to pass the exhaust port 24. FIG. 1 illustrates the end of the power-generating portion of the combustion/exhaust stroke. Once the head of piston 16 passes the exhaust port 24, both the exhaust valve 24 and the intake valve 30 open to allow pressurized air to be forced into the combustion chamber 14 and expel the exhaust gases through the exhaust port 24. Accordingly, the cycle begins again as illustrated in FIG. 1B.

The particular configuration and operation of the improved two-stroke engine described herein provides several operational benefits over known two-stroke engines. In particular, cross contamination of fuel and lubricating oil (common in known two-stroke engines) is eliminated in the described embodiment. As a result, the need for oil additives in the fuel is eliminated and oil consumption and undesirable emissions are reduced compared to known two-stroke engines. Further, the described embodiment experiences better fuel efficiency because there is reduced opportunity for unburned fuel to be expelled from the combustion chamber through the exhaust port. Finally, with the exhaust port 24 positioned near the bottom of the cylinder 12, the length of time during the combustion/exhaust stroke before a flow path through the exhaust port is opened is longer, which increases the power-generating portion of the combustion/exhaust stroke.

While the present invention has been particularly shown and described with reference to the foregoing preferred and alternative embodiments, those skilled in the art will understand that many variations may be made therein without departing from the spirit and scope of the invention as defined in the following claims. By way of example only, while the described embodiment discloses isolating the exhaust port 24 from the lubricating oil in the crank case 34 by using an exhaust valve 28, one skilled in the art would recognize, in light of this disclosure, that such isolation could be achieved without an exhaust valve 28 if the exhaust port 24 were positioned such and the piston 16 was sufficiently large that the wall of the piston 16 completely covered the exhaust port 24 when the piston reached the top of the induction/compression stroke. Accordingly, this description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements. Further, the use of the words “first”, “second”, and the like do not alone imply any temporal order to the elements identified. The invention is limited only by the following claims.

What is claimed is:

1. A two-stroke internal combustion engine, comprising:
a piston slideably disposed within a cylinder, said cylinder and said piston together defining a combustion chamber, and said piston being configured to have a two-stroke cycle comprising a downstroke when said piston slides from an upper position to a lower position within said cylinder in and an upstroke when said piston slides from said lower position to said upper position within said cylinder;
a supply of lubricating fluid; and
wherein said supply of lubricating fluid is substantially isolated from any fuel.

2. The engine of claim 1, wherein said combustion chamber is substantially fluidly-isolated from said supply of lubricating fluid.

3. The engine of claim 1, further comprising:
an exhaust port in said cylinder configured to provide a flow path from said combustion chamber for exhaust gases during at least a portion of said downstroke; and
an intake port in said cylinder configured to provide a flow path for air into said combustion chamber during at least a portion of at least said upstroke.

4. The engine of claim 3, wherein said intake port is physically located at an upper position in said cylinder relative to said exhaust port.

5. The engine of claim 3, wherein said intake port in said cylinder is configured to provide a flow path for air into said combustion chamber during at least a portion of said downstroke and during at least a portion of said upstroke.

6. The engine of claim 3, wherein said exhaust port is configured to provide a flow path from said combustion chamber only for a time period occurring within a latter half of said downstroke.

7. The engine of claim 6, wherein said exhaust port is physically positioned within said cylinder such that a flow path from said combustion chamber through said exhaust port is only possible during a time period occurring within a latter half of said downstroke.

8. The engine of claim 6, further comprising an exhaust port valve configured to selectively open and close said flow path from said combustion chamber through said exhaust port.

9. The engine of claim 3, further comprising a means for providing pressurized air into said combustion chamber through said intake port.

10. The engine of claim 3, further comprising an intake valve that selectively opens and closes a flow path into said combustion chamber through said intake port.

11. The engine of claim 1, further comprising:
an exhaust port in said cylinder that is capable of providing a flow path from said combustion chamber; and
a means for providing fuel to said combustion chamber only when no flow path exists from said combustion chamber through said exhaust port.

12. In a two-stroke internal combustion engine having at least one cylinder and one piston that together define a combustion chamber, said piston having a cycle comprised of a downstroke when said piston slides from an upper position to a lower position within said cylinder and said piston having an upstroke when said piston slides from said lower position to said upper position in said cylinder, a method of operating said engine, comprising:
substantially preventing fuel from mixing with a supply of lubricating fluid used to lubricate moving parts in the engine.

13. The method of claim 12, further comprising the step of isolating said combustion chamber from said supply of lubricating fluid.

14. The method of claim 12, further comprising the step of preventing fuel from being provided to said combustion chamber during said downstroke.

15. The method of claim 12, further comprising:
injecting pressurized air into said combustion chamber during at least a portion of said downstroke; and
providing air and fuel into said combustion chamber during at least a portion of said upstroke.

16. The method of claim 15, further comprising:
providing a flow path from said combustion chamber through an exhaust port during a portion of said downstroke.

17. The method of claim 15, further comprising:
providing a flow path from said combustion chamber through an exhaust port while said pressurized air is being injected into said combustion chamber during at least a portion of said downstroke.

18. The method of claim 17, wherein said step of providing a flow path from said combustion chamber includes opening an exhaust valve.

19. The method of claim 16, wherein said flow path from said combustion chamber is provided during a time period occurring within a latter half of said downstroke.

20. The method of claim 16, further comprising compressing an air/fuel mixture in said combustion chamber during at least a portion of said upstroke.

21. A two-stroke internal combustion engine, comprising:
a piston slideably disposed within a cylinder, said cylinder and said piston together defining a combustion chamber, and said piston being configured to have a two-stroke cycle comprising a downstroke when said piston slides from an upper position to a lower position within said cylinder, and said piston being configured to have an upstroke when said piston slides from said lower position to said upper position within said cylinder;
an exhaust port in said cylinder capable of providing a flow path from said cylinder to expel exhaust gases;
an intake port in said cylinder configured to provide a flow path for air into said cylinder; and
wherein said intake port is physically located at a higher position within said cylinder than said exhaust port.

22. The engine of claim 21, further comprising means for expelling exhaust gases from said combustion chamber through said exhaust port during said downstroke.

23. The engine of claim 22, wherein said means for expelling comprises a source of pressurized air that injects air into said combustion chamber through said intake port.

24. The engine of claim 21, further comprising means for closing said exhaust port during a time period that fuel is provided to said combustion chamber.

25. The engine of claim 21, further comprising:
means for selectively opening and closing said intake port.

26. The engine of claim 21, further comprising means for providing fuel to said combustion chamber during said upstroke of said piston.

27. In a two-stroke internal combustion engine having at least one cylinder and one piston that together define a combustion chamber, said piston having a cycle comprised of a downstroke when said piston slides from an upper position to a lower position within said cylinder and said piston having an upstroke when said piston slides from said lower position to said upper position in said cylinder, a method of operating said engine, comprising:
injecting pressurized air into said combustion chamber through an intake port during said downstroke;
providing a flow path from said combustion chamber through an exhaust port during at least a portion of said downstroke;
closing said flow path from said combustion chamber through said exhaust port;
providing a mixture of air and fuel to said combustion chamber during at least a portion of said upstroke;
after said air/fuel mixture is provided to said combustion chamber, blocking said intake port;
compressing said air/fuel mixture; and
combusting said air/fuel mixture.

28. A stroke internal combustion engine, comprising:
a combustion chamber;
a means for providing a flow path for expelling exhaust gases from said combustion chamber;
a means for providing a flow path for providing air into said combustion chamber;
a means for isolating said combustion chamber from lubricating fluid.

29. The two-stroke internal combustion engine of claim 28, further comprising means for supplying a lubricating fluid; and wherein said means for isolating includes a means for isolating said means for supplying a lubricating fluid from said combustion chamber.
